(19) United States
(12) Patent Application Publication
(10) Pub. No.: US 2024/0336493 A1
(43) Pub. Date: Oct. 10, 2024

(54) PRELITHIATION REAGENT FOR LITHIUM-ION BATTERY (LIB), AND PREPARATION METHOD THEREFOR AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Jianlin Miao, Foshan, Guangdong (CN); Changdong Li, Foshan, Guangdong (CN); Dingshan Ruan, Foshan, Guangdong (CN); Yong Cai, Foshan, Guangdong (CN); Weijian Liu, Foshan, Guangdong (CN)

(21) Appl. No.: 18/293,367

(22) PCT Filed: Dec. 1, 2022
(86) PCT No.: PCT/CN2022/135781

§ 371 Date: Jan. 30, 2024

(30) Foreign Application Priority Data
Jan. 27, 2022 (CN) 202210101748.5

(51) Int. Cl. C01G 49/00; H01M 10/0525

(52) U.S. Cl. CPC C01G 49/0027; H01M 10/0525; C01P 2002/72; C01P 2004/03; C01P 2004/61; C01P 2004/84; C01P 2006/40

(57) ABSTRACT

The present disclosure discloses a prelithiation reagent for a lithium-ion battery (LIB), and a preparation method therefor and use thereof. The prelithiation reagent for the LIB has a chemical formula of Li₅FeO₄@C; and the prelithiation reagent for the LIB has a structure of secondary particles generated from the agglomeration of Li₅FeO₄ primary particles, and carbon is coated on a surface of the Li₅FeO₄ primary particles. In the present disclosure, a carbon source is mixed with a soluble salt of Fe, such that Fe ions are attached to the carbon source; then aqueous ammonia is added, such that a hydroxide with small particles and high dispersibility is generated; and then a solvothermal reaction is conducted to obtain a nano-scale oxide.

### TECHNICAL FIELD

The present disclosure belongs to the technical field of lithium-ion batteries (LIBs), and in particular relates to a prelithiation reagent for an LIB, and a preparation method therefor and use thereof.

### BACKGROUND

During the initial charge process of an LIB, a solid electrolyte interphase (SEI) film will be formed on a surface of an anode, during which a part of active lithium in a cathode material needs to be consumed, and this part of lithium cannot be returned to the cathode material during a discharge process of the battery, which leads to a decrease in the discharge capacity and initial Coulomb efficiency (ICE) of the cathode material. The prelithiation technology is an effective way to compensate for capacity loss of a cathode material caused by the formation of an SEI film on an anode of an LIB. A principle of the prelithiation technology is as follows: an SEI film is formed on a surface of an anode before the delithiation of a cathode active material to reduce Li⁺ loss of the cathode material in this process, thereby improving the service efficiency of Li⁺ and the capacity of the battery.

Lithium supplementation for an anode is currently the most common method for prelithiation of a battery. A principle of the method is as follows: a prelithiation reagent (such as an inert lithium powder) is allowed to directly contact an anode material through a potential difference to enable a chemical reaction, such that an anode is lithium-intercalated previously, and the anode lithium-intercalated previously by this method is used to assemble an LIB, which can greatly improve the ICE. However, this method requires an additional previous lithium-intercalation process in a battery assembly process, it is not easy to control a degree of lithiation, and the reactivity of the prelithiation reagent is high, which poses a potential safety hazard.

Lithium supplementation for a cathode is to add a small amount of a prelithiation reagent during a stirring process of a cathode material slurry, and during the initial charge process of a battery, the prelithiation reagent can provide additional lithium for the formation of an SEI film to compensate for the loss of active lithium in the cathode material, thereby improving the Coulomb efficiency and capacity of the battery. Materials each with an antifluorite structure such as Li₅FeO₄ have higher irreversible capacity and are ideal prelithiation materials for cathode. However, these materials have extremely poor electric conductivity and air stability, and difficulty in preparation, and require a high preparation cost, making it difficult to achieve large-scale industrial production and application.

### SUMMARY

The following is a summary of subject matters described in detail herein. This summary is not intended to limit a scope of protection of claims.

The present disclosure provides a prelithiation reagent for an LIB, and a preparation method therefor and use thereof. The prelithiation reagent can provide enough Lit for the formation of an SEI film on a surface of an anode during the initial charge of an LIB to reduce the loss of Lit in a cathode material and improve the Coulomb efficiency and capacity of the LIB.

According an aspect of the present disclosure, a prelithiation reagent for an LIB is provided. The prelithiation reagent for the LIB has a chemical formula of Li₅FeO₄@C; and the prelithiation reagent for the LIB has a structure of secondary particles generated from the agglomeration of Li₅FeO₄ primary particles, and carbon is coated on a surface of the Li₅FeO₄ primary particles.

In some embodiments of the present disclosure, a content of carbon in the prelithiation reagent for the LIB is 1 wt. % to 20 wt. %.

In some embodiments of the present disclosure, the Li₅FeO₄ primary particles have a particle size of less than or equal to 10 μm.

The present disclosure also provides a preparation method of the prelithiation reagent for the LIB described above, including the following steps:
S1: mixing a soluble salt of Fe, a carbon source, and a solvent to obtain a mixed solution A;
S2: adding aqueous ammonia to the mixed solution A to obtain a mixed solution B;
S3: subjecting the mixed solution B to a solvothermal reaction, and subjecting a resulting mixture to solid-liquid separation (SLS) to obtain a Fe₂O₃/carbon composite; and
S4: mixing the Fe₂O₃/carbon composite with a lithium source, and subjecting a resulting mixture to a high-temperature solid-phase reaction in an inert atmosphere to obtain the prelithiation reagent for the LIB.

In some embodiments of the present disclosure, in S1, the soluble salt of Fe is at least one selected from the group consisting of a sulfate, a nitrate, an acetate, and a chloride.

In some embodiments of the present disclosure, in S1, the carbon source is at least one selected from the group consisting of a carbon-containing compound and elemental carbon, the carbon-containing compound is at least one selected from the group consisting of polyaniline (PANI), polypyrrole (PPy), polyacetylene (PA), polythiophene (PTh), and polydopamine (PDA), and the elemental carbon is at least one selected from the group consisting of graphene, carbon nanotube (CNT), carbon fiber, graphdiyne (GDY), carbon black, and Ketjen black; and the carbon source is subjected to an acidification treatment. The acidification treatment is achieved by stirring the carbon source in an oxidizing acid, with a reaction equation as follows: R=C+3 H⁺+3O²⁻→R—COOH+H₂O. After an acidified carbon source with carboxyl group is mixed with the soluble salt of Fe, Fe ions are more dispersedly attached to the carbon source.

In some embodiments of the present disclosure, in S1, a molar ratio of Fe in the soluble salt of Fe to C in the carbon source is 1:(0.13-3.22).

In some embodiments of the present disclosure, in S1, the solvent is at least one selected from the group consisting of water, ethanol, ethylene glycol (EG), diethylene glycol (DEG), propanol, isopropanol, propylene glycol (PG), glycerol, n-butanol, isobutanol, tert-butanol, N-methylpyrrolidone (NMP), N,N-dimethylformamide (DMF), and dimethylsulfoxide (DMSO).

In some embodiments of the present disclosure, in S2, a molar ratio of the aqueous ammonia to the Fe in the soluble salt of Fe is (2-3): 1.

In some embodiments of the present disclosure, in S3, the solvothermal reaction is conducted at a temperature of 150° C. to 250° C. and a pressure of 0.5 MPa to 10 MPa. Further, the solvothermal reaction is conducted for 1 h to 10 h.

In some embodiments of the present disclosure, in S3, the solvothermal reaction is conducted in a high-temperature and high-pressure reactor, and a volume of the mixed solution B is 50% to 85% of a volume of the high-temperature and high-pressure reactor.

In some embodiments of the present disclosure, in S4, the high-temperature solid-phase reaction is conducted at 500° C. to 800° C. for 8 h to 20 h.

In some embodiments of the present disclosure, in S4, the lithium source is at least one selected from the group consisting of lithium hydroxide, lithium oxide, lithium peroxide, lithium fluoride, and lithium nitrate.

In some embodiments of the present disclosure, in S4, a molar ratio of Fe in the Fe₂O₃/carbon composite to Li in the lithium source is 1:(5-10).

In some embodiments of the present disclosure, in S4, the inert atmosphere is at least one selected from the group consisting of nitrogen, argon, and helium.

The present disclosure also provides use of the prelithiation reagent for the LIB described above in a cathode material of an LIB or a cathode sheet of an LIB. Specifically, the prelithiation reagent for the LIB is added during a stirring process of a cathode material slurry of an LIB, where an addition amount of the prelithiation reagent for the LIB is 0.5% to 10% of a mass of the cathode material slurry of an LIB; or the prelithiation reagent for the LIB is independently prepared into a slurry and then uniformly coated on a surface of a cathode sheet of an LIB, where a coating amount of the prelithiation reagent for the LIB is 0.5% to 10% of a mass of the cathode material of an LIB, and an LIB assembled by the cathode sheet can show an effect of lithium supplementation at a battery formation stage.

According to a preferred embodiment of the present disclosure, the present disclosure at least has the following beneficial effects.

1. The prelithiation reagent Li₅FeO₄@C provided by the present disclosure includes rich active Lit and has higher irreversible capacity.

2. The preparation method of the prelithiation reagent provided by the present disclosure involves a simple process, where a sintering process of the prelithiation reagent is simple without sintering for multiple times, and a pure-phase compound can be obtained by only one sintering at a lower temperature.

3. A precursor used in a traditional solid-phase method is usually presented as hundred-nano-scale or even micro-scale particles, and primary particles of a prepared prelithiation reagent are too large, resulting in poor electric conductivity. In the present disclosure, a carbon source is mixed with a soluble salt of Fe, such that Fe ions are attached to the carbon source; then aqueous ammonia is added, such that a hydroxide with small particles and high dispersibility is generated; and then a solvothermal reaction is conducted to obtain a nano-scale oxide. The carbon source can also act as a barrier among particles in a subsequent sintering process to slow down the growth of primary particles and avoid the generation of large single-crystal particles. The prelithiation reagent prepared by the method has smaller primary particles, makes a Li⁺ deintercalation path shorter during charge, and leads to prominent rate performance.

4. Due to the extremely-poor air stability and electric conductivity of the material Li₅FeO₄ with an antifluorite structure, a surface of the Li₅FeO₄ primary particles provided by the present disclosure is coated with a layer of carbon material, which can avoid the direct contact between the host material and air, slow down a reaction with water and carbon dioxide in air, and improve the air stability of the material; and the coating of the carbon material can improve the electric conductivity of the prelithiation reagent and lead to a higher capacity at a large current.

### BRIEF DESCRIPTION OF THE DRAWINGS

The drawings are used to provide a further understanding of the technical solutions herein, constitute a part of the description, and explain the technical solutions herein in conjunction with examples of the present disclosure, without limiting the technical solutions herein. The present disclosure is further described below with reference to accompanying drawings and examples.

FIG. 1 is a scanning electron microscopy (SEM) image of the prelithiation reagent of Example 1 of the present disclosure;

FIG. 2 is an SEM image of the prelithiation reagent of Comparative Example 1 of the present disclosure;

FIG. 3 shows X-ray Diffraction (XRD) patterns of the prelithiation reagents in Example 1 and Comparative Example 1 of the present disclosure; and

FIG. 4 shows charging curves of the prelithiation reagents in Example 1 and Comparative Example 1 of the present disclosure.

### DETAILED DESCRIPTION

The concepts and technical effects of the present disclosure are clearly and completely described below in conjunction with examples, so as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Example 1

In this example, a prelithiation reagent for an LIB was prepared, which had a chemical formula of Li₅FeO₄@C. The prelithiation reagent had a structure of secondary particles generated from the agglomeration of Li₅FeO₄ primary particles; carbon was coated on a surface of the Li₅FeO₄ primary particles at a carbon content of 10 wt. %; and the Li₅FeO₄ primary particles had a particle size of less than or equal to 10 μm. A specific preparation process was as follows:
(1) FeCl₃·6H₂O and acidified graphene were added in a molar ratio of C:Fe=0.59:0.41 to absolute ethanol, and a resulting mixture was subjected to ultrasonic dispersion to obtain a mixed solution A, where the acidified graphene was prepared by stirring graphene in 10 wt. % nitric acid for 1 h;
(2) aqueous ammonia was added dropwise to the mixed solution A under ultrasonic stirring for dispersion to obtain a mixed solution B of a hydroxide and graphene, where a molar ratio of aqueous ammonia to Fe³⁺ was 3:1;
(3) the mixed solution B was transferred to a high-temperature and high-pressure reactor to undergo a solvothermal reaction for 4 h at a temperature of 180° C. and a pressure of 1.0 MPa, a resulting mixture was filtered, and a resulting filter cake was washed and dried to obtain a Fe₂O₃/carbon composite, where a volume of the mixed solution B was 80% of a volume of the high-temperature and high-pressure reactor; and
(4) the Fe₂O₃/carbon composite was mixed with lithium hydroxide in a molar ratio of Fe:Li=1:5.0, a resulting mixture was subjected to a high-temperature solid-phase reaction at 680° C. for 12 h in a nitrogen atmosphere, and a resulting product was cooled to obtain the prelithiation reagent Li₅FeO₄@C.

### Example 2

In this example, a prelithiation reagent for an LIB was prepared, which had a chemical formula of Li₅FeO₄@C. The prelithiation reagent had a structure of secondary particles generated from the agglomeration of Li₅FeO₄ primary particles; carbon was coated on a surface of the Li₅FeO₄ primary particles at a carbon content of 5 wt. %; and the Li₅FeO₄ primary particles had a particle size of less than or equal to 10 μm. A specific preparation process was as follows:
(1) FeNO₃·9H₂O and acidified PPy were added in a molar ratio of C:Fe=0.40:0.54 to a mixed solvent of water and ethanol in a mass ratio of 1:1, and a resulting mixture was subjected to ultrasonic dispersion to obtain a mixed solution A, where the acidified PPy was prepared by stirring PPy in 15 wt. % permanganic acid for 2 h;
(2) aqueous ammonia was added dropwise to the mixed solution A under ultrasonic stirring for dispersion to obtain a mixed solution B of a hydroxide and PPy, where a molar ratio of aqueous ammonia to Fe³⁺ was 2.5:1;
(3) the mixed solution B was transferred to a high-temperature and high-pressure reactor to undergo a solvothermal reaction for 2 h at a temperature of 200° C. and a pressure of 1.5 MPa, a resulting mixture was filtered, and a resulting filter cake was washed and dried to obtain a Fe₂O₃/carbon composite, where a volume of the mixed solution B was 75% of a volume of the high-temperature and high-pressure reactor; and
(4) the Fe₂O₃/carbon composite was mixed with lithium hydroxide in a molar ratio of Fe:Li=1:5.5, a resulting mixture was subjected to a high-temperature solid-phase reaction at 650° C. for 8 h in a nitrogen atmosphere, and a resulting product was cooled to obtain the prelithiation reagent Li₅FeO₄@C.

### Example 3

In this example, a prelithiation reagent for an LIB was prepared, which had a chemical formula of Li₅FeO₄@C. The prelithiation reagent had a structure of secondary particles generated from the agglomeration of Li₅FeO₄ primary particles; carbon was coated on a surface of the Li₅FeO₄ primary particles at a carbon content of 2 wt. %; and the Li₅FeO₄ primary particles had a particle size of less than or equal to 10 μm. A specific preparation process was as follows:
(1) FeCl₃·6H₂O and acidified CNT were added in a molar ratio of C:Fe=0.21:0.71 to EG, and a resulting mixture was stirred for dispersion to obtain a mixed solution A, where the acidified CNT was prepared by stirring CNT in 5 wt. % perchloric acid;
(2) aqueous ammonia was added dropwise to the mixed solution A under ultrasonic stirring for dispersion to obtain a mixed solution B of a hydroxide and CNT, where a molar ratio of aqueous ammonia to Fe³⁺ was 2:1;
(3) the mixed solution B was transferred to a high-temperature and high-pressure reactor to undergo a solvothermal reaction for 1 h at a temperature of 220° C. and a pressure of 2.0 MPa, a resulting mixture was filtered, and a resulting filter cake was washed and dried to obtain a Fe₂O₃/carbon composite, where a volume of the mixed solution B was 85% of a volume of the high-temperature and high-pressure reactor; and
(4) the Fe₂O₃/carbon composite was mixed with lithium hydroxide in a molar ratio of Fe:Li=1:6.0, a resulting mixture was subjected to a high-temperature solid-phase reaction at 750° C. for 14 h in a nitrogen atmosphere, and a resulting product was cooled to obtain the prelithiation reagent Li₅FeO₄@C.

### Example 4

In this example, a prelithiation reagent for an LIB was prepared, which had a chemical formula of Li₅FeO₄@C. The prelithiation reagent had a structure of secondary particles generated from the agglomeration of Li₅FeO₄ primary particles; carbon was coated on a surface of the Li₅FeO₄ primary particles at a carbon content of 15 wt. %; and the Li₅FeO₄ primary particles had a particle size of less than or equal to 10 μm. A specific preparation process was as follows:
(1) FeCl₃·6H₂O and acidified carbon black were added in a molar ratio of Fe:C=0.24:0.70 to a mixed solvent of water and EG in a mass ratio of 1:1, and a resulting mixture was subjected to ultrasonic dispersion to obtain a mixed solution A, where the acidified carbon black was prepared by soaking carbon black in 20 wt. % chloric acid;
(2) aqueous ammonia was added dropwise to the mixed solution A under ultrasonic stirring for dispersion to obtain a mixed solution B of a hydroxide and carbon black, where a molar ratio of aqueous ammonia to Fe³⁺ was 3:1;
(3) the mixed solution B was transferred to a high-temperature and high-pressure reactor to undergo a solvothermal reaction for 4 h at a temperature of 220° C. and a pressure of 3.0 MPa, a resulting mixture was filtered, and a resulting filter cake was washed and dried to obtain a Fe₂O₃/carbon composite, where a volume of the mixed solution B was 70% of a volume of the high-temperature and high-pressure reactor; and
(4) the Fe₂O₃/carbon composite was mixed with lithium hydroxide in a molar ratio of Fe:Li=1:6.5, a resulting mixture was subjected to a high-temperature solid-phase reaction at 600° C. for 20 h in a nitrogen atmosphere, and a resulting product was cooled to obtain the prelithiation reagent Li₅FeO₄@C.

### Comparative Example 1

In this comparative example, a prelithiation reagent was prepared. A preparation process was different from Example 1 in that the carbon source, the lithium source, and the Fe₂O₃ were directly mixed; and a specific process was as follows:
commercial nano-scale Fe₂O₃, glucose, and lithium hydroxide were mixed in molar ratios of C:Fe=0.59:0.41 and Fe:Li=1:5.0, a resulting mixture was subjected to a high-temperature solid-phase reaction at 700° C. for 12 h in a nitrogen atmosphere, and a resulting product was cooled to obtain the prelithiation reagent.

### Comparative Example 2

In this comparative example, a prelithiation reagent for an LIB was prepared. A preparation process was different from Example 1 in that no carbon source was added in step (1); and a specific process was as follows:
(1) FeCl₃·6H₂O was added to absolute ethanol solvent, and a resulting mixture was subjected to ultrasonic dispersion to obtain a mixed solution A;
(2) aqueous ammonia was added dropwise to the mixed solution A under ultrasonic stirring for dispersion to obtain a mixed solution B of a hydroxide, where a molar ratio of aqueous ammonia to Fe³⁺ was 3:1;
(3) the mixed solution B was transferred to a high-temperature and high-pressure reactor to undergo a solvothermal reaction for 4 h at a temperature of 180° C. and a pressure of 1.0 MPa, a resulting mixture was filtered, and a resulting filter cake was washed and dried to obtain Fe₂O₃, where a volume of the mixed solution B was 80% of a volume of the high-temperature and high-pressure reactor; and
(4) the Fe₂O₃ was mixed with lithium hydroxide in a molar ratio of Fe:Li=1:5.0, a resulting mixture was subjected to a high-temperature solid-phase reaction at 680° C. for 12 h in a nitrogen atmosphere, and a resulting product was cooled to obtain the prelithiation reagent Li₅FeO₄.

### Test Example 1

The prelithiation reagents of Examples 1 to 4 and Comparative Examples 1 to 2 were each used as a cathode active material to prepare a cathode sheet, and the cathode sheet was assembled into an LIB for a charge-discharge test. Test results were shown in Table 1.

TABLE 1
Primary particle size, carbon content, and initial
discharge capacity of each of the prelithiation
reagents in the examples and comparative examples

| | Primary | | Electric | Charge | Charge |
|---|---|---|---|---|---|
| | particle | Carbon | conduc- | capacity | capacity |
| | size | content | tivity | at 0.01 C | at 0.2 C |
| | (μm) | (%) | (S/cm) | (mAh/g) | (mAh/g) |
| Example 1 | 2.32 | 9.45 | 2.32 | 682 | 672 |
| Example 2 | 3.56 | 4.76 | 1.96 | 688 | 664 |
| Example 3 | 3.85 | 1.98 | 1.74 | 685 | 640 |
| Example 4 | 2.08 | 14.32 | 2.15 | 673 | 653 |
| Compar- | 12.35 | 9.65 | 0.0023 | 675 | 195 |
| ative | | | | | |
| Example | | | | | |
| 1 | | | | | |
| Compar- | 15.68 | 0.13 | ~0 | 632 | 12.3 |
| ative | | | | | |
| Example | | | | | |
| 2 | | | | | |

It can be seen from Table 1 that each of the examples has small primary particles, and shows higher electric conductivity because the primary particles are coated with carbon; each of the comparative examples has large primary particles, and shows extremely-low or even no electric conductivity. Although carbon coating is conducted in Comparative Example 1, this comparative example shows very low electric conductivity, because the coating is achieved through simple solid-phase mixing and sintering and carbon is not well coated on the material surface. Although the charge capacity of each of the examples and comparative examples at 0.01 C is higher than 600 mAh/g; the charge capacity of each of the comparative examples at 0.2 C is extremely low. Wherein, because no carbon source is introduced in Comparative Example 2, the electric conductivity is 0 and there is almost no charge capacity. Since no carbon coating is conducted or the effect of carbon coating is poor, no carbon material acts as a barrier in the sintering process, such that the primary particles continue to grow and Li⁺ is not easy to be released during charge at a large current. While, the charge capacity of each of the examples is still higher than 600 mAh/g, indicating that the preparation method provided by the present disclosure can effectively improve the electric conductivity of the prelithiation reagent Li₅FeO₄, that is, the carbon coating can greatly improve the electric conductivity of the material.

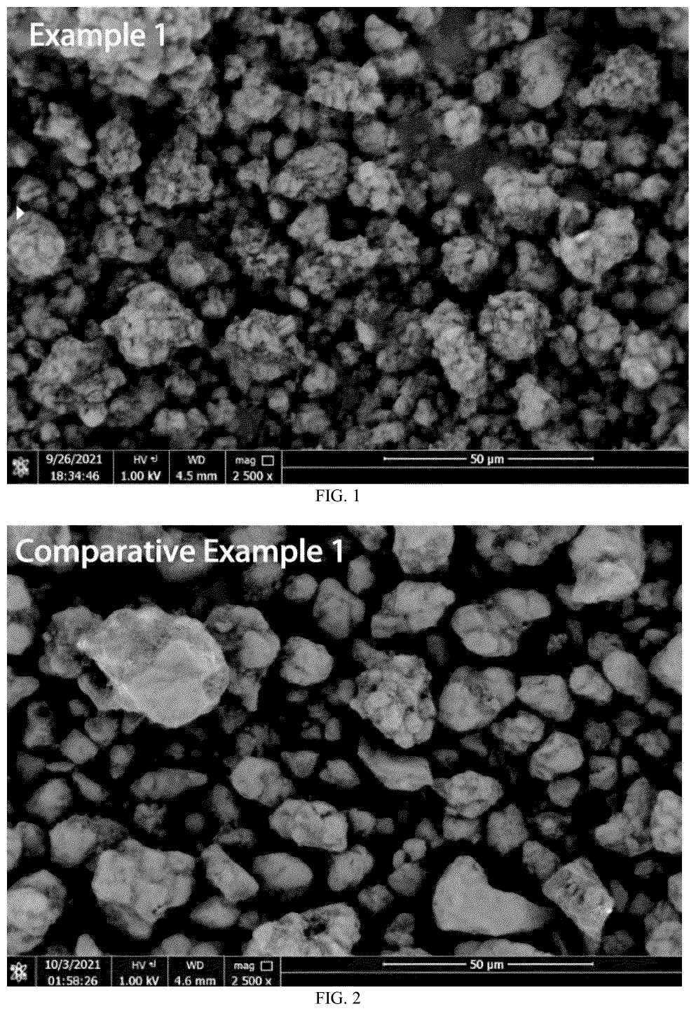

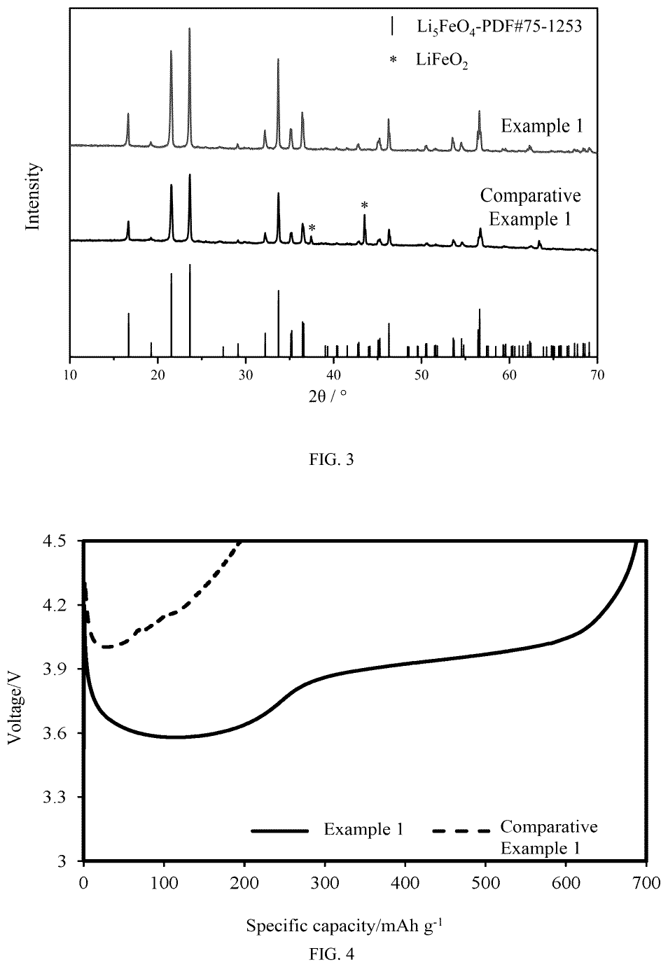

FIG. 1 and FIG. 2 are SEM images of the prelithiation reagents in Example 1 and Comparative Example 1, respectively, and it can be seen from the figures that primary particles of the prelithiation reagent in Example 1 are small and show prominent inter-particle dispersibility; while particles of the prelithiation reagent in Comparative Example 1 are significantly larger than that in Example 1, which is not conducive to the diffusion of Lit. FIG. 3 shows XRD patterns of the prelithiation reagents in Example 1 and Comparative Example 1, and it can be seen that the prelithiation reagent prepared in Example 1 has a higher peak intensity, and is a pure phase of Li₅FeO₄; and the prelithiation reagent prepared in Comparative Example 1 includes an impurity phase of Li₅FeO₂ and has a lower main-phase peak intensity, because the raw material has large particles and is difficult to react, and the reaction between Fe₂O₃ and lithium hydroxide is incomplete. FIG. 4 shows charge-discharge curves of the prelithiation reagents in Example 1 and Comparative Example 1 at 0.2 C, and it can be seen that Example 1 has a charge plateaus at each of 3.6 V and 4.0 V, and a high charge capacity; and Comparative Example 1 has a high charge voltage plateaus and a low capacity.

### Test Example 2

With LiCoO₂ as a cathode active material, each of the prelithiation reagents prepared in Examples 1 to 4 and Comparative Examples 1 to 2 was added during a stirring process of a slurry at an amount 5 wt. % of the cathode active material to prepare a cathode sheet; with graphite as an anode active material, an electrode sheet was prepared; and an LIB was assembled to undergo a charge-discharge test and a cycling test. Test results were shown in Table 2.

TABLE 2
Electrochemical performance test results of
LiCoO₂ full batteries with one of the prelithiation
reagents of the examples and comparative examples

| | | | | Capacity |
|---|---|---|---|---|
| | Specific charge | Specific | | retention rate |
| Prelithiation | capacity | discharge | ICE | after 500 cycles |
| reagent | (mAh/g) | capacity (mAh/g) | (%) | (%) |
| Example 1 | 190.1 | 183.7 | 96.65 | 88.7 |
| Example 2 | 189.5 | 182.3 | 96.20 | 88.2 |
| Example 3 | 189.1 | 180.6 | 95.51 | 87.5 |
| Example 4 | 189.7 | 181.0 | 95.41 | 87.2 |
| Comparative | 184.9 | 174.0 | 94.10 | 82.1 |
| Example | | | | |
| 1 | | | | |
| Comparative | 185.2 | 174.7 | 94.30 | 83.6 |
| Example | | | | |
| 2 | | | | |
| Without | 185.0 | 173.6 | 93.84 | 82.5 |
| prelithiation | | | | |
| reagent | | | | |

It can be seen from Table 2 that, in the slurry stirring process for the LiCoO₂ battery, each of the prelithiation reagents of the examples and comparative examples is added, and then a test is conducted at a current of 0.2 C and a voltage range of 3.0 V to 4.48 V; and the addition of each of the prelithiation reagents of the examples greatly improves the charge and discharge capacities and the ICE of the battery, while the addition of each of the prelithiation reagents of the comparative examples does not significantly improve the performance of the battery. It is indicated that the addition of each of the prelithiation reagents prepared in the examples can improve the specific capacity and Coulomb efficiency, and can also greatly improve the cycling performance.

The examples of present disclosure are described in detail above with reference to the accompanying drawings, but the present disclosure is not limited to the above examples. Within the scope of knowledge possessed by those of ordinary skill in the technical field, various changes can also be made without departing from the purpose of the present disclosure. In addition, the examples and features therein in the present disclosure may be combined with each other in a non-conflicting situation.

1. A prelithiation reagent for a lithium-ion battery (LIB), wherein the prelithiation reagent for the LIB has a chemical formula of Li₅FeO₄@C; and the prelithiation reagent for the LIB has a structure of secondary particles generated from the agglomeration of Li₅FeO₄ primary particles, and carbon is coated on a surface of the Li₅FeO₄ primary particles.

2. The prelithiation reagent for the LIB according to claim 1, wherein a content of carbon in the prelithiation reagent for the LIB is 1 wt. % to 20 wt. %.

3. The prelithiation reagent for the LIB according to claim 1, wherein the Li₅FeO₄ primary particles each have a particle size of less than or equal to 10 μm.

4. A preparation method of the prelithiation reagent for the LIB according to claim 1, comprising the following steps:
S1: mixing a soluble salt of Fe, a carbon source, and a solvent to obtain a mixed solution A;
S2: adding aqueous ammonia to the mixed solution A to obtain a mixed solution B;
S3: subjecting the mixed solution B to a solvothermal reaction, and subjecting a resulting mixture to solid-liquid separation (SLS) to obtain a Fe₂O₃/carbon composite; and
S4: mixing the Fe₂O₃/carbon composite with a lithium source, and subjecting a resulting mixture to a high-temperature solid-phase reaction in an inert atmosphere to obtain the prelithiation reagent for the LIB.

5. The preparation method according to claim 4, wherein in S1, the carbon source is at least one selected from the group consisting of a carbon-containing compound and elemental carbon, the carbon-containing compound is at least one selected from the group consisting of polyaniline (PANI), polypyrrole (PPy), polyacetylene (PA), polythiophene (PTh), and polydopamine (PDA), and the elemental carbon is at least one selected from the group consisting of graphene, carbon nanotube (CNT), carbon fiber, graphdiyne (GDY), carbon black, and Ketjen black; and the carbon source is subjected to an acidification treatment.

6. The preparation method according to claim 4, wherein in S1, a molar ratio of Fe in the soluble salt of Fe to C in the carbon source is 1:(0.13-3.22).

7. The preparation method according to claim 4, wherein in S1, the solvent is at least one selected from the group consisting of water, ethanol, ethylene glycol (EG), diethylene glycol (DEG), propanol, isopropanol, propylene glycol (PG), glycerol, n-butanol, isobutanol, tert-butanol, N-methylpyrrolidone (NMP), N,N-dimethylformamide (DMF), and dimethylsulfoxide (DMSO).

8. The preparation method according to claim 4, wherein in S2, a molar ratio of the aqueous ammonia to the Fe in the soluble salt of Fe is (2-3): 1.

9. The preparation method according to claim 4, wherein in S3, the solvothermal reaction is conducted at a temperature of 150° C. to 250° C. and a pressure of 0.5 MPa to 10 MPa.

10. The preparation method according to claim 4, wherein in S4, the high-temperature solid-phase reaction is conducted at 500° C. to 800° C. for 8 h to 20 h.

11. Use of the prelithiation reagent for the LIB according to claim 1 in a cathode material of an LIB or a cathode sheet of an LIB.

12. A preparation method of the prelithiation reagent for the LIB according to claim 2, comprising the following steps:
S1: mixing a soluble salt of Fe, a carbon source, and a solvent to obtain a mixed solution A;
S2: adding aqueous ammonia to the mixed solution A to obtain a mixed solution B;
S3: subjecting the mixed solution B to a solvothermal reaction, and subjecting a resulting mixture to solid-liquid separation (SLS) to obtain a Fe₂O₃/carbon composite; and
S4: mixing the Fe₂O₃/carbon composite with a lithium source, and subjecting a resulting mixture to a high-temperature solid-phase reaction in an inert atmosphere to obtain the prelithiation reagent for the LIB.

13. A preparation method of the prelithiation reagent for the LIB according to claim 3, comprising the following steps:
S1: mixing a soluble salt of Fe, a carbon source, and a solvent to obtain a mixed solution A;
S2: adding aqueous ammonia to the mixed solution A to obtain a mixed solution B;
S3: subjecting the mixed solution B to a solvothermal reaction, and subjecting a resulting mixture to solid-liquid separation (SLS) to obtain a Fe₂O₃/carbon composite; and
S4: mixing the Fe₂O₃/carbon composite with a lithium source, and subjecting a resulting mixture to a high-temperature solid-phase reaction in an inert atmosphere to obtain the prelithiation reagent for the LIB.

14. Use of the prelithiation reagent for the LIB according to claim 2 in a cathode material of an LIB or a cathode sheet of an LIB.

15. Use of the prelithiation reagent for the LIB according to claim 3 in a cathode material of an LIB or a cathode sheet of an LIB.
